(19) United States
(12) Patent Application Publication
(10) Pub. No.: US 2017/0180090 A1
(43) Pub. Date: Jun. 22, 2017

(54) DISTRIBUTED MULTI-POINTS COORDINATED DYNAMIC CELL CONTROL APPARATUS AND CONTROL METHOD THEREOF, AND DISTRIBUTED MULTI-POINTS COORDINATED DYNAMIC CELL CONFIGURATION METHOD

(71) Applicant: ELECTRONICS AND TELECOMMUNICATIONS RESEARCH INSTITUTE, Daejeon (KR)

(72) Inventors: SoonGi PARK, Daejeon (KR); Yong Seouk CHOI, Daejeon (KR); Tae Joong KIM, Daejeon (KR)

(73) Assignee: ELECTRONICS AND TELECOMMUNICATIONS RESEARCH INSTITUTE, Daejeon (KR)

(21) Appl. No.: 15/382,550

(22) Filed: Dec. 16, 2016

(30) Foreign Application Priority Data
Dec. 18, 2015 (KR) 10-2015-0182197
Dec. 18, 2015 (KR) 10-2015-0182200
Dec. 16, 2016 (KR) 10-2016-0172532
Dec. 16, 2016 (KR) 10-2016-0172533

(51) Int. Cl. H04L 5/00; H04W 24/02; H04W 72/04; H04W 24/10

(52) U.S. Cl. CPC H04L 5/0035; H04W 24/10; H04W 24/02; H04W 72/0446; H04W 72/046

(57) ABSTRACT

Disclosed is an apparatus for managing a plurality of transmission points (TPs) including: configuring at least one grouping cell by logically grouping a plurality of spot coverages formed by the plurality of TPs within an overall coverage in a plurality of subbands, respectively, within an overall system band; and operating at least one of the plurality of subbands as a capacity layer for providing capacity to UE.

### CROSS-REFERENCE TO RELATED APPLICATION

This application claims priority to and the benefit of Korean Patent Application No. 10-2015-0182197, 10-2015-0182200, 10-2016-0172532, and 10-2016-0172533 filed in the Korean Intellectual Property Office on Dec. 18, 2015, Dec. 18, 2015, Dec. 16, 2016, and Dec. 16, 2016, the entire contents of which are incorporated herein by reference.

### BACKGROUND OF THE INVENTION

(a) Field of the Invention

The present invention relates to a distributed multi-points coordinated dynamic cell control apparatus and a control method thereof, and a distributed multi-points coordinated dynamic cell configuration method.

(b) Description of the Related Art

As a capacity increasing method for coping with an explosive increase in mobile traffic in a mobile communication system, there have been considered three methods currently. The first method is to spectrum efficiency of frequency, the second method is to increase a use frequency, and the third method is to densify a small cell.

The third method to densify a small cell based on a technology and an operation of the existing cellular communication system may increase the overall system capacity. However, the third method provides low capacity to user equipment (user equipment) at a cell boundary and high capacity to UE at a cell center due to inter-cell interference, and therefore has a problem in that it causes inequality of providing capacity depending on the location of the UE, may increase a frequency of handover in proportion to a moving speed of the UE, and may not secure sustainability of services demanding high capacity at the time of the movement of the UE. In other words, the cell densification based on the technology and operation of the existing cellular communication system may cause the inequality of capacity depending on the location of the UE, aggravate the moving performance, and may not secure the sustainability of services.

### SUMMARY OF THE INVENTION

The present invention has been made in an effort to provide a distributed multi-points coordinated dynamic cell control apparatus and a control method thereof, and a distributed multi-points coordinated dynamic cell configuration method having advantages of solving inequality of capacity depending on a location of UE, solving aggravation of moving performance, and securing sustainability of services, due to cell densification.

Further, the present invention has been made in an effort to provide a distributed multi-points coordinated dynamic cell control apparatus and a control method thereof having advantages of effectively supporting capacity required for UE by effectively controlling cells defined as a capacity layer.

An exemplary embodiment of the present invention provides a distributed multi-points coordinated dynamic cell control method in an apparatus for managing a plurality of transmission points (TPs). The distributed multi-points coordinated dynamic cell control method includes: configuring at least one grouping cell by logically grouping a plurality of spot coverages formed by the plurality of TPs within an overall coverage in a plurality of subbands, respectively, within an overall system band; operating at least one of the plurality of subbands as a capacity layer for providing capacity to UE; and operating at least another band or other bands as a coverage layer to which the UE is always connected. The operating at least one of the plurality of subbands as the capacity layer may include adding at least one cell of the capacity layer to the UE or deleting or changing the at least one cell from the UE, through a cell of the coverage layer.

The operating at least one of the plurality of subbands as the capacity layer may include: adding a grouping cell of at least one subband corresponding to the capacity layer to the UE based on a measurement report from the UE; selecting a grouping cell to be activated among the grouping cells added to the UE; and activating the selected grouping cell.

The operating at least one of the plurality of subbands as the capacity layer may further include designating a subframe to be monitored to allow the UE to confirm scheduling information of the activated cell and transmitting the designated subframe to the UE.

The transmitting may include transmitting a bit map representing the subframe to be monitored to the UE.

The activating may include switching a grouping cell of any one subband corresponding to the capacity layer to grouping cells of other subbands corresponding to the capacity layer, based on a distance or time, and the grouping cell of any one subband and the grouping cells of the other subbands at least partially may overlap each other.

The switching may include activating the grouping cells of the other subbands, prior to deactivating the grouping cell of the any one subband.

The switching may include deactivating the grouping cell of the any one subband after deactivating the grouping cell of the any one subband.

The activating may include transmitting a MAC control element, and each bit of the MAC control element may be mapped to the grouping cells of each subband and the activation and the deactivation of the corresponding grouping cell may be determined depending on values of each bit.

The distributed multi-points coordinated dynamic cell control method may further include: individually performing resource allocation on the grouping cells of the plurality of subbands, respectively or integrate the grouping cells of the plurality of subband to perform the resource allocation thereto.

The configuring may include forming one spot coverage as a sector coverage formed by at least two TPs located at different locations and the coverage formed by one TP may be divided into a plurality of sector coverages and the overall coverage is formed as a coverage by the plurality of TPs.

Another exemplary embodiment of the present invention provides a distributed multi-points coordinated dynamic cell control apparatus for managing a plurality of transmission points (TPs). The distributed multi-points coordinated dynamic cell control apparatus includes a processor and a transceiver. The processor divides an overall system band into a plurality of subbands, operates at least one of the plurality of subbands as a capacity layer for providing capacity to UE, operates at least another band or other bands as a coverage layer to which the UE is always connected, configures at least one cell within overall coverage using spot coverage formed by the plurality of TPs in the plurality of subbands, respectively, and adds a cell of the coverage layer to the UE or changes or deletes the cell of the capacity layer added to the UE through the cell of the coverage layer and

The transceiver transmits/receives a radio signal for adding, changing, or deleting the cell of the capacity layer.

The processor may logically group the plurality of spot coverages in the plurality of subbands, respectively, to configure at least one cell and form one spot coverage as a sector coverage formed by at least two TPs located at different locations and the coverage formed by one TP may be divided into a plurality of sector coverages and the overall coverage may be formed as a coverage by the plurality of TPs.

The processor may add the cell of at least one capacity layer to the UE through the cell of the coverage layer and use a MAC control element to dynamically activate and deactivate the cell of the subband corresponding to the capacity layer.

Each bit of the MAC control element may be mapped to the grouping cells of each subband and the activation and the deactivation of the corresponding grouping cell may be determined depending on values of each bit.

The processor may determine switching a grouping cell of any one subband corresponding to the capacity layer to grouping cells of other subbands corresponding to the capacity layer, based on a distance or time and activates the grouping cells of the other subbands, prior to deactivating the grouping cell of the any one subband and the grouping cell of any one subband and the grouping cells of the other subbands at least partially may overlap each other.

Yet another exemplary embodiment of the present invention provides a distributed multi-points coordinated dynamic cell configuration method in an apparatus for managing a plurality of transmission points (TPs). A distributed multi-points coordinated dynamic cell configuration method includes: forming one spot coverage as a sector coverage formed by at least two TPs located at different locations, and configuring at least one cell by logically grouping a plurality of virtualization spot coverages formed within an overall coverage, in which the coverage formed by one TP may be divided into a plurality of sector coverages and the overall coverage may be formed as a coverage by the plurality of TPs.

The distributed multi-points coordinated dynamic cell configuration may further include: dividing an overall system band into a plurality of subbands and operating the overall system band, in which the configuring may include grouping the plurality of virtual spot coverages into the at least one cell using one virtualization spot coverage as a minimum unit, in the plurality of subbands, respectively.

The distributed multi-points coordinated dynamic cell configuration method may further include: selecting a cell of at least one of the plurality of subbands as a cell of a coverage layer to which the UE is always connected; and selecting at least one cell of at least another subband of the plurality of subbands as a cell of a capacity layer to which the UE is additionally connected to provide capacity to the UE.

The selecting may include dynamically changing the cell of the capacity layer based on at least one of interference, mobility, and capacity.

### BRIEF DESCRIPTION OF THE DRAWINGS

FIG. 1 is a diagram illustrating an example of a cloud base station structure according to an exemplary embodiment of the present invention.

FIG. 2 is a diagram illustrating an example of an antenna distributed arrangement structure according to an exemplary embodiment of the present invention.

FIG. 3 is a diagram illustrating coverage that may be formed by antennas of each DU illustrated in FIG. 2.

FIG. 4 is a diagram illustrating coverages per subband according to the antenna distributed arrangement structure illustrated in FIG. 2.

FIG. 5 is a diagram illustrating a dynamic cell configuration according to an exemplary embodiment of the present invention.

FIG. 6 is a diagram illustrating an example in which the dynamic cell configuration illustrated in FIG. 5 is differently configured per subband.

FIG. 7 is a diagram illustrating an example of an activation cell within the overall coverage according to an exemplary embodiment of the present invention.

FIG. 8 is a diagram illustrating another example of a cell configuration in the same antenna distributed arrangement structure as FIG. 2.

FIGS. 9 and 10 each are diagrams illustrating an example of solving radio interference using the cell configuration illustrated in FIG. 8.

FIG. 11 is a diagram illustrating a moving path of UE according to an exemplary embodiment of the present invention.

FIG. 12 is a diagram illustrating an example of a history in which the moving path of the UE is recorded.

FIG. 13 is a diagram illustrating a method for allocating a UE-specific resource depending on UE following scheduling according to an exemplary embodiment of the present invention.

FIG. 14 is a diagram illustrating an example of a UE following scheduling bit map according to an exemplary embodiment of the present invention.

FIG. 15 is a diagram illustrating an example of UE following bit information according to an exemplary embodiment of the present invention.

FIG. 16 is a diagram illustrating a resource management method depending on the UE following scheduling according to an exemplary embodiment of the present invention.

FIG. 17 is a diagram illustrating an example of a power-based dynamic cell configuration according to an exemplary embodiment of the present invention.

FIG. 18 is a diagram illustrating another example of a power-based dynamic cell configuration according to an exemplary embodiment of the present invention.

FIGS. 19 and 20 each are diagrams illustrating still another example of a power-based dynamic cell configuration according to an exemplary embodiment of the present invention.

FIG. 21 is a diagram illustrating an example of an antenna according to an exemplary embodiment of the present invention.

FIGS. 22A and 22B are diagrams illustrating an example of a method for operating a dynamic cell according to an exemplary embodiment of the present invention.

FIGS. 23A and 23B are diagrams illustrating another example of a method for operating a dynamic cell according to an exemplary embodiment of the present invention.

FIG. 24 is a diagram illustrating the same type of grouped cells per subband.

FIG. 25 is a diagram illustrating other types of grouped cells per subband.

FIGS. 26 and 27 each are diagrams illustrating an example of a communication method using a dynamic cell selection in a millimeter wave-based system according to an exemplary embodiment of the present invention.

FIG. 28 is a diagram illustrating an example of a dynamic cell selection within one subband.

FIGS. 29 to 32 are diagrams illustrating an example of performing cell switching to other subbands to provide capacity to each UE.

FIG. 33 is a diagram illustrating an example of applying an activation/inactivation control method of an S cell presented in CA of the existing LTE-A system to a cell of a capacity layer according to an exemplary embodiment of the present invention.

FIG. 34 is a diagram illustrating a method for activating or deactivating a cell of a capacity layer according to an exemplary embodiment of the present invention.

FIG. 35 is a diagram describing a method for dynamically allocating a cell resource of a subband corresponding to a capacity layer according to an exemplary embodiment of the present invention.

FIG. 36 is a diagram illustrating a method for activating or deactivating an MAC CE-based S cell according to an exemplary embodiment of the present invention.

FIG. 37 is a diagram illustrating a distributed multi-points coordinated dynamic cell control apparatus according to an exemplary embodiment of the present invention.

### DETAILED DESCRIPTION OF THE EMBODIMENTS

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification and claims, unless explicitly described to the contrary, “comprising” any components will be understood to imply the inclusion of other elements rather than the exclusion of any other elements.

Throughout the specification, a terminal may refer to a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like and may also include all or some of the functions of the MT, the MS, the AMS, the HR-MS, the SS, the PSS, the AT, the UE, and the like

Further, the base station (BS) may be called an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (RS) serving as a base station, a high reliability relay station (HR-RS) serving as a base station, small base stations (a femto base station (femoto BS), a home node B (HNB), a home eNodeB (HeNB), a pico base station (pico BS), a metro base station (metro BS), a micro base station (micro BS), and the like), and the like and may also include all or some of the functions of the ABS, the HR-RS, the node B, the eNodeB, the AP, the RAS, the BTS, the MMR-BS, the RS, the RN, the ARS, the HR-RS, the small base stations, and the like.

Hereinafter, a distributed multi-points coordinated dynamic cell control apparatus and a control method thereof, and a distributed multi-points coordinated dynamic cell configuration method according to an exemplary embodiment of the present invention will be described in detail with reference to the accompanying drawings.

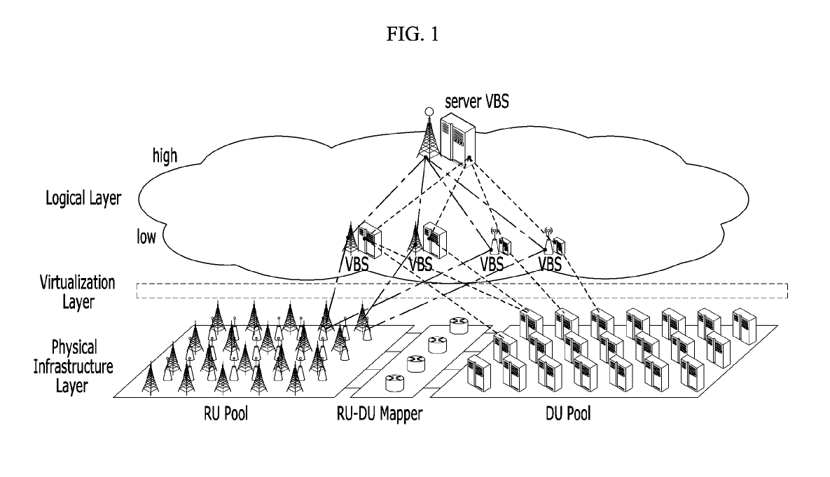

FIG. 1 is a diagram illustrating an example of a cloud base station structure according to an exemplary embodiment of the present invention.

Referring to FIG. 1, in a mobile communication system in addition to LTE, base stations are each divided into a radio unit (RU) and a digital unit (DU), in which the RU is divided into plural number to be distributedly arranged and the DUs are concentrated on one place to be managed. Therefore, a radio unit (RU) pool, a digital unit (DU) pool, and an RU-DU mapper mapping the RU to the DU are present in a physical infrastructure layer. The RUs of the RU pool are distributedly arranged and the DUs of the DU pool are connected to each other and controls at least one RU connected to one DU. The RU-DU mapper maps a specific UR to a specific DU to connect therebetween. The RU may have only an antenna mounted therein and may also perform a PHY or medium access control (MAC) function. The RU may have coverages of a macro cell, a micro cell, and a pico cell based on a power control and may have individual coverage of the macro cell, the micro cell, and the pico cell. Further, the antenna mounted in the RU may also be an omnidirectional antenna and a directional antenna and may also be several beamforming antennas.

Several virtual base stations (VBSs) and one giant server base station (server VBS) may also be generated at a logical layer based on a virtual layer and

That is, a specific RU and a specific DU may be selected, a logical virtual base station (VBS) performing the same function as the existing base station by connecting the selected RU and DU to the RU-DU mapper may be generated, and several small-scale virtual base stations (VBSs) and a large-scale server virtual base station are generated, thereby reducing interference using a cooperative radio on wireless and increase system capacity.

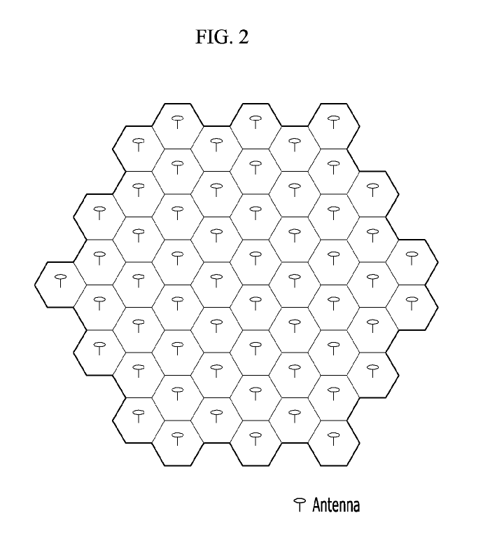

FIG. 2 is a diagram illustrating an example of an antenna distributed arrangement structure according to an exemplary embodiment of the present invention.

Referring to FIG. 2, the plurality (for example, 57) of RUs in which antennas are each mounted are distributedly disposed and at least one DU for processing the plurality of RUs in the DU pool may be selected depending on a time-spatial load. That is, the selected DUs may centrally process the plurality of distributed RUs.

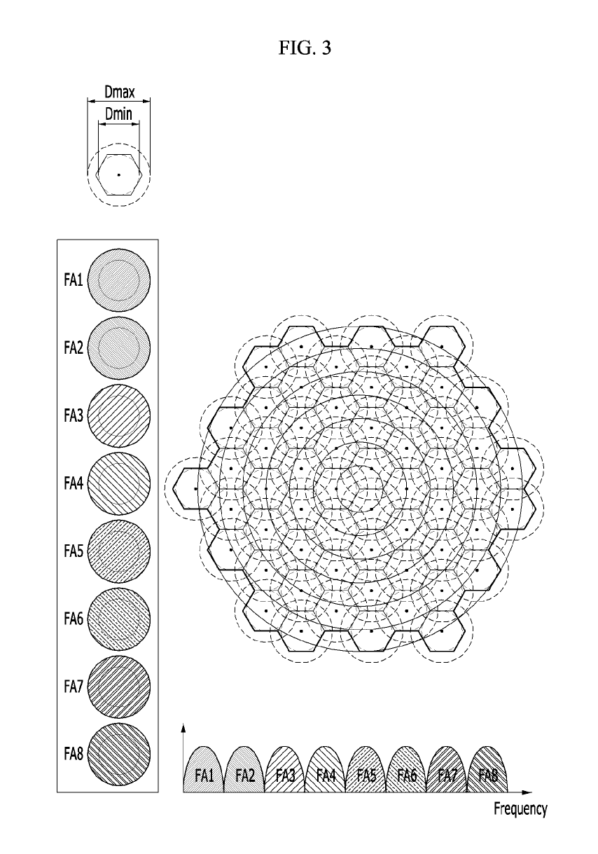

FIG. 3 is a diagram illustrating coverage that may be formed by antennas of each DU illustrated in FIG. 2.

Referring to FIG. 3, the antennas of each DU may have minimum coverage and maximum coverage. Dmin means a radius of minimum coverage to prevent one antenna from overlapping with coverage of adjacent antennas and Dmax means a radius of maximum coverage of one antenna at the time of increasing the power of the antenna to increase the coverage. Hereinafter, the coverage that may be formed by one antenna is called spot coverage.

To form the spot coverage, the overall system bandwidth (overall system BW) that one antenna uses may be operated by being divided into a plurality of subbands FA1, FA2, FA3, FA4, FA5, FA6, FA7, and FA8. At this point, a bandwidth of one subband is called a unit system bandwidth (unit system BW).

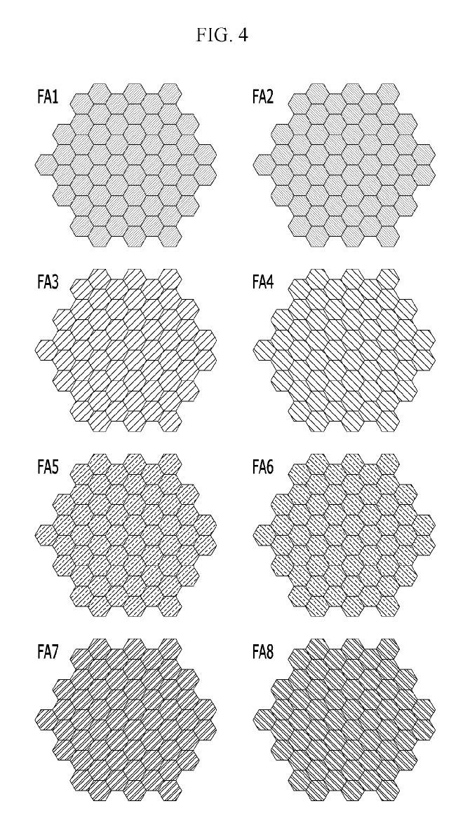

FIG. 4 is a diagram illustrating coverages per subband according to the antenna distributed arrangement structure illustrated in FIG. 2.

Referring to FIG. 4, one spot coverage is divided into 8 subbands by one antenna, and therefore may be handled as a total of 8 spot element carrier coverages. Therefore, when the coverage depending on the antenna distributed arrangement illustrated in FIG. 3 is considered as one group coverage, one group coverage has 57 spot element carrier coverages per subband and the one spot coverage has eight spot element carrier coverages, and therefore one group coverage has a total of 456 spot element carrier coverages.

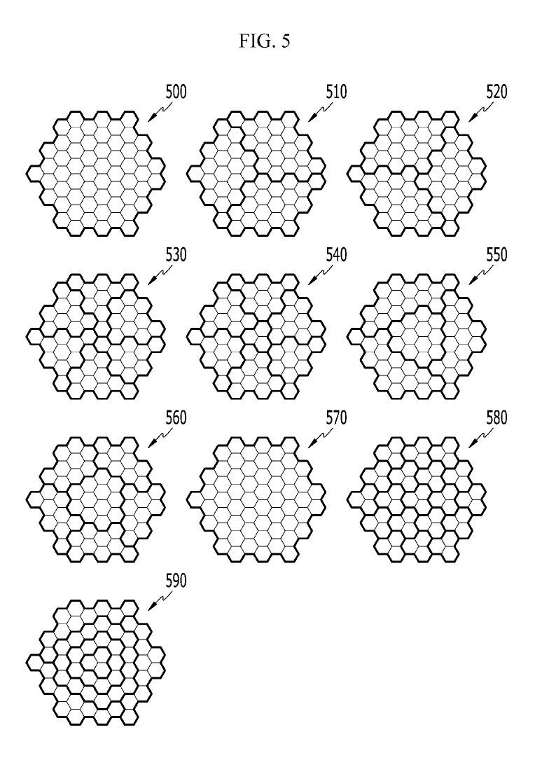

FIG. 5 is a diagram illustrating a dynamic cell configuration according to an exemplary embodiment of the present invention.

57 spot element carrier coverages belonging to a specific subband may be grouped as illustrated in FIG. 5. The grouping meaning the even locally different antennas [hereinafter, transmission point (TP)] are handled as one cell.

Referring to 500, 57 spot element carrier coverages belonging to the specific subband are bound into one group to configure one cell. Referring to 510 and 520, similar to the existing sector concept, 19 spot element carrier coverages are bound into one group to configure three cells. At this point, as illustrated in 510 and 520, 19 spot element carrier coverages may be grouped differently in location. Referring to 530, 9 spot element carrier coverages are grouped to configure three cells and 10 spot element carrier coverages are grouped to configure three cells. Referring to 540, 9 spot element carrier coverages are grouped to configure six cells and 9 spot element carrier coverages are grouped to configure one cell. Referring to 550, 15 spot element carrier coverages are grouped to configure three cells and 12 spot element carrier coverages are grouped to configure one cell. Referring to 560, 9 spot element carrier coverages are grouped to configure five cells and 12 spot element carrier coverages are grouped to configure one cell. Referring to 570, one spot element carrier coverage configures one cell. Referring to 580, three spot element carrier coverages are grouped to configure nineteen cells and referring to 590, 3 spot element carrier coverages are grouped to configure one cell, 9 spot element carrier coverages are grouped to configure one cell, 15 spot element carrier coverages are grouped to configure one cell, and 10 spot element carrier coverages are grouped to configure one cell. The cell configuration illustrated in 590 illustrates a donut-like cell configuration. The grouping cell is a new concept cell configuration that is not substantially present conventionally. If it is assumed that a plurality of (for example, 57) TPs locally distributed are centrally processed at one location, one TP or a plurality of TPs may be grouped as illustrated in FIG. 5 to be operated like one cell. When the overall group coverage (i.e., coverage configuring 57 TPs) is considered as the existing macro cell, the spot element carrier coverages belonging to the certain subband in all the TPs may also be operated like an omni cell by the logical grouping and as illustrated in 510 and 520, a sector cell having a similar concept to the existing sector may also be operated and various cells having various types different from the existing concept may be dynamically configured.

Further, a plurality of TPs may not be disposed at a predetermined distance and interval. For example, the plurality of TPs may be irregularly disposed at a proper location not to generate a coverage hole and as illustrated in FIG. 5, the grouped cell may also be configured as an amorphous cell, not pentagonal grouping. To help the understanding of description, the exemplary embodiment of the present invention will mainly describe TPs that are regularly fixed and disposed. The coverage provided by a combination of the spot coverages provided by 57 TPs in the specific subband is called as the overall coverage. It is assumed that one peak capacity of the spot element carrier coverage in the specific subband is 1.

As illustrated in 570, when one TP configures one cell, the theoretical peak capacity of the overall coverage is 57. However, the inter-cell interference is increased and thus it is difficult to systematically provide the actual theoretical peak capacity and the probability that the user will be located at the cell edge having large interference is increased, such that the system capacity may be reduced due to the user and average providing capacity to the user of the worst case of 5% is relatively reduced. Further, when the user moves at a high speed, frequent handover is generated and performance of handover (early HO, late HO, wrong HO) is reduced, such that a frequency of radio link failure (RLF) recovery is increased.

Meanwhile, when the plurality of TPs are grouped into a large scale as illustrated in 500, the capacity that the specific subband for the overall coverage may theoretically provide is not 57 but 1 and therefore the capacity is reduced to a level of 1/57 compared to 570. However, the frequent handover does not occur when the user moves at a high speed and the handover disappears in the overall coverage, such that the handover performance is higher than 570 and the frequency of the RLF recovery is reduced.

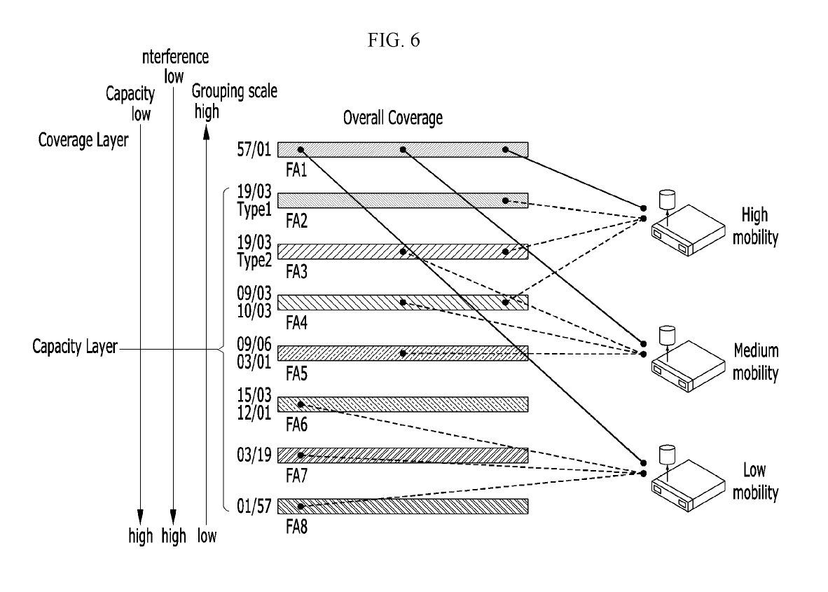

FIG. 6 is a diagram illustrating an example in which the dynamic cell configuration illustrated in FIG. 5 is differently configured per subband.

In FIG. 6, “57/01” means that as illustrated in 500 of FIG. 5, 57 spot element carrier coverages are grouped to operate one cell within the overall coverage. Type 1 and type 2 of “03/19” each mean that as illustrated in 510 and 520 of FIG. 5, 19 spot element carrier coverages are grouped to operate three cells within the overall coverage. “01/57” means that as illustrated in 570 of FIG. 5, each of the spot element carrier coverages configures one cell to operate 57 cells within the overall coverage. As such, “x/y” groups x spot element carrier coverages to operate y cells within the overall coverage.

As illustrated in FIG. 6, the cell configuration may be different per subband. For example, in subband FA1, a cell is configured within the overall coverage depending on “57/01”, in subband FA2, a cell is configured within the overall coverage depending on type 1 of “19/03”, and in subband FA3, a cell is configured within the overall coverage depending on type 2 of “19/03”. In subband FA4, a cell is configured within the overall coverage depending on “09/03” and “10/03”, in subband FA5, a cell is configured within the overall coverage depending on “09/06” and “03/01”, and in subband FA6, a cell is configured within the overall coverage depending on “15/03” and “12/01”. Further, in subband FA7, a cell is configured within the overall coverage depending on “03/19” and in subband FA8, a cell is configured within the overall coverage depending on “01/57”.

As such, subbands FA1, FA2, FA3, FA4, FA5, FA6, FA7, and FA8 are listed from the top to the bottom, and when the cell configuration of each subband FA1, FA2, FA3, FA4, FA5, FA6, FA7, and FA8 is determined as illustrated in FIG. 6, increasing the grouping scale toward the top and decreasing the group scale toward the bottom mean that in terms of interference, an interference area is decreased toward the top and increased toward the bottom

In addition, it may be considered that in terms of capacity, the overall system capacity is decreased toward the top and the overall system capacity is increased toward the bottom.

Here, “57/01” operates 57 spot element carrier coverages as one cell and therefore is very advantageous in mobility. Therefore, the subband FA1 may play a role of the coverage layer in the form in which all the UEs are always connected using a cell of the subband FA1 as an anchor. The rest subbands FA2 to FA8 may be used as the capacity layer to provide the optimal capacity to meet the mobility of the UE and the system load. The UE may be connected by selecting the cell of the capacity layer.

The methods for grouping type 1 and type 2 of “19/03” are the same but the locations of the grouped spot element carrier coverages are different. Therefore, in a process of selecting 510 or 520 in FIG. 5 when the capacity is provided by connecting cells at the capacity layer, the cell of the subband having the smallest interference may be selected at the current location of the UE. However, in the dynamic cell configuration and method per subband, the coverage layer for making a virtualization macro cell effect need not be limited only to one subband and the coverage layer may be operated in different subbands. Further, at least one grouping cell may also be operated in one subband corresponding to the coverage layer to provide the function of the coverage layer. That is, when the two grouping cells are operated to provide the function of the two coverage layers, the two grouping cells may be the grouping cell of the same subband and may also be the grouping cell in different subbands.

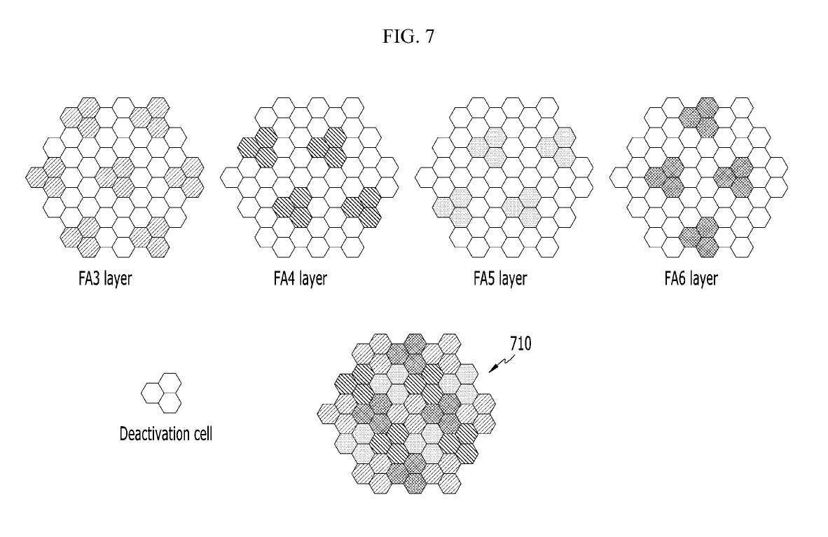

FIG. 7 is a diagram illustrating an example of an activation cell within the overall coverage according to an exemplary embodiment of the present invention.

Referring to FIG. 7, some of the cells grouped into the spot element carrier coverages may be deactivated in some cases. If the system capacity required for 57 spot element carrier coverages within the overall coverage is not large, only cells that are not adjacent to each other may be activated in consideration of the interference. That is, when the cell is configured in the subbands FA3, FA4, FA5, and FA7 as illustrated in 580 of FIG. 5, if the cells are activated so that the activation cells of the subbands FA3, FA4, FA5, and FA7 do not overlap each other, as illustrated in FIG. 7, the cell may be operated to prevent the mutual interference from occurring in the subbands FA3, FA4, FA5, and FA7, as illustrated in 710 of FIG. 7. The cells per subband may also be activated/deactivated to cause the slight overlapping.

As such, various types of cells may be configured in consideration of the interference, the capacity, the mobility of the UE, or the like. Various cell configuration methods as described above are not fixed but may be dynamically changed. For example, as the cells at the coverage layer are always activated and the load is continuously generated, the cells at the capacity layer may be sequentially activated and after all the UEs using the cells corresponding to the capacity layer of the specific subband move other capacity layers or coverage layers, the cells of the layer are reconfigured, and then the UEs use the cells of the layer again.

Even the UEs at the coverage layer also move to other layers and then the layers may be dynamically configured and then may also be used again.

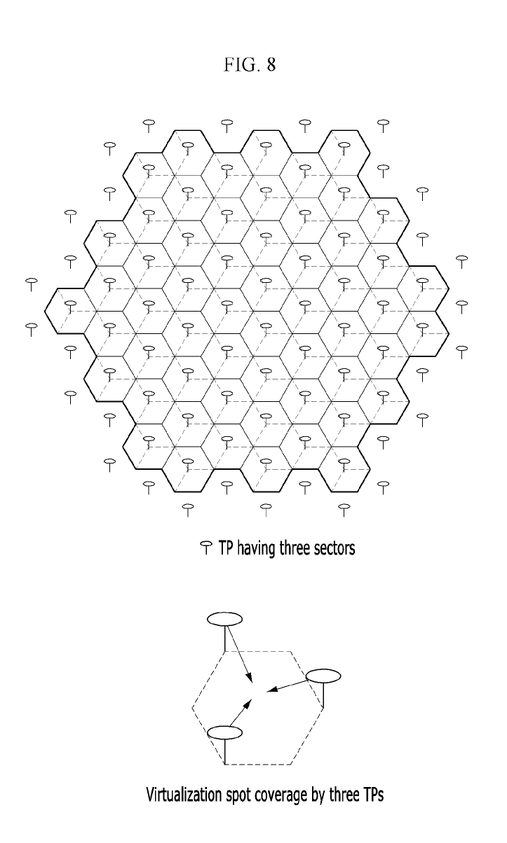

FIG. 8 is a diagram illustrating another example of a cell structure in the same antenna distributed arrangement structure as FIG. 2.

One TP (antenna) may also have an omni-directional radiation pattern but may also have a directional radiation pattern. That is, the spot coverage by one TP may be divided into a plurality of sector coverages due to the directional radiation pattern of the TP. For example, when the spot coverage by one TP is divided into three sector coverages, the sector coverages of three TPs at different locations may be collected to form one spot coverage.

As illustrated in FIG. 8, three TPs may be collected to form one spot coverage like a dotted line. The so formed spot coverages may be operated based on the concept as illustrated in FIGS. 5 to 7. That is, three TP may be collected to configure virtualization spot coverage and the virtualization spot coverages may consist of 8 spot element carrier coverages depending on 8 subbands as described above. Therefore, 57 spot element carrier coverages belonging to each subband may be operated as the grouped cell as illustrated in FIG. 5, as illustrated in FIG. 6, may be configured to have different cell configurations per subband as illustrated in FIG. 6, and as illustrated in FIG. 7, the grouped cell may be activated or deactivated based on the interference, the capacity, or the like.

Meanwhile, as the operation frequency is getting higher, it is vulnerable to blockage. As the radio interference between the TP and the user, there may be a radio interference occurring by objects due to motions such as building, a person, and a bus and by a user's hand, a radio interference occurring by a rotation of a user, or the like. If the radio interference occurs at a high frequency, channel quality is suddenly changed and communication is immediately interrupted. However, as illustrated in FIG. 8, if the spot coverage is formed by the plurality of TPs, a path is formed in different directions by each TP, and therefore the radio interference may be prevented as described above.

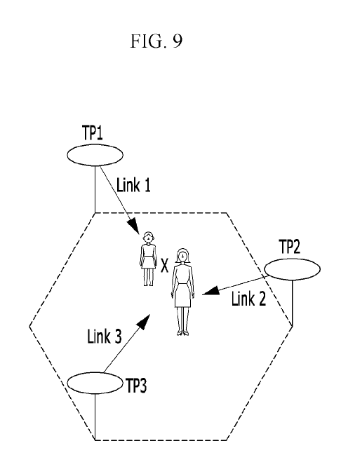

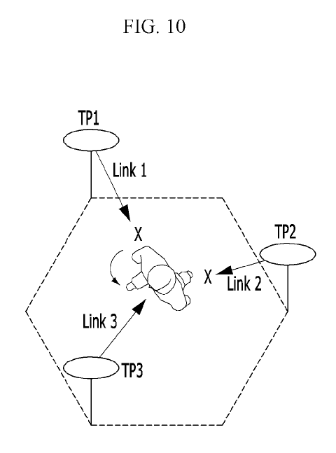

FIGS. 9 and 10 each are diagrams illustrating an example of solving radio interference using the cell configuration illustrated in FIG. 8.

Referring to FIG. 9, when one spot coverage is formed by TP1, TP2, and TP3, user A may simultaneously receive data through link 1, link 2, and link 3 connected with the TP1, the TP2, and the TP3, respectively. At this point, even the radio interference occurs in the link 1 due to the user B, data of the TP1 may be transmitted to the user A through the TP2 and the TP3 based on the cooperation among the TP1, the TP2, and the TP3. Further, if the TP1, the TP2, and the TP3 are transmitted by a joint transmission (JT) technique, data may be transmitted to the user A through the TP2 and the TP3 even if the radio interference occurs in the link 1.

Further, referring to FIG. 10, when one spot coverage is formed by the TP1, the TP2, and the TP3, the link 3 may secure wireless quality even if the wireless quality of the link 1 and the link 2 deteriorate due to the rotation of the user A. If data are transmitted/received only from the link 1, the link 1 may be disconnected due to the rotation of the user A. In this case, the transmission and reception of the data may be resumed through the link 3.

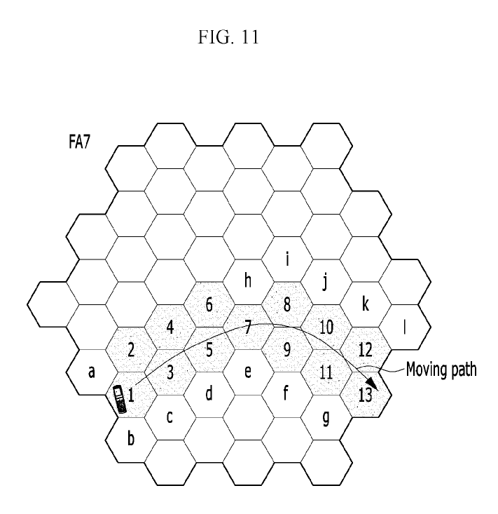

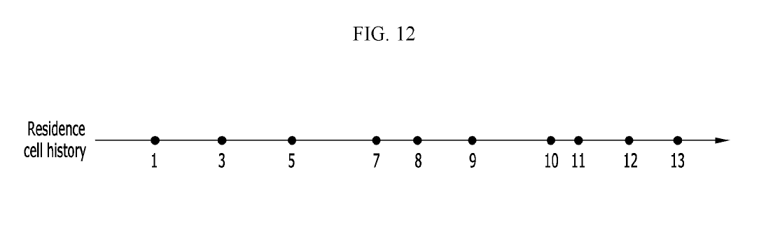

FIG. 11 is a diagram illustrating a moving path of UE according to an exemplary embodiment of the present invention and FIG. 12 is a diagram illustrating an example of a history in which the moving path of the UE is recorded.

As illustrated in FIG. 11, when the UE moves through cells 1, 3, 5, 7, 8, 9, 10, 11, 12, and 13 within the overall coverage of the specific subband FA7, the path through which the UE actually moves is recorded in a residence cell history as illustrated in FIG. 12.

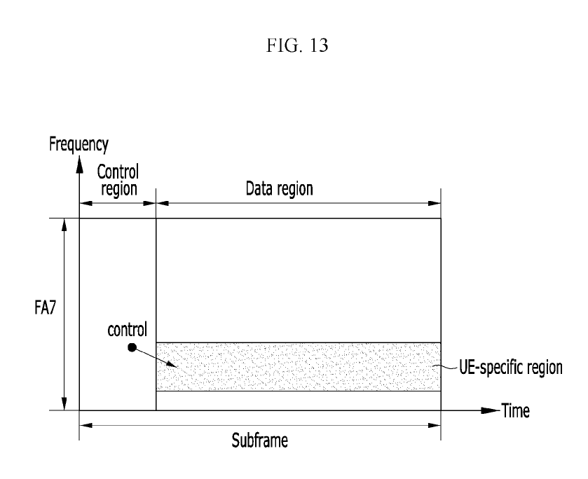

FIG. 13 is a diagram illustrating a method for allocating a UE-specific resource depending on UE following scheduling according to an exemplary embodiment of the present invention.

The DU that manages the spot element carrier coverages within the overall coverage of the specific subband FA7 transmits UE following bit information and UE-specific resource information to be allocated to the corresponding UE. The UE following bit information and the UE-specific resource information to be allocated to the corresponding UE may be transmitted through the control region of the subframe. Further, the DU transmits the UE following scheduling bit map to the corresponding UE through the control region. The terminal following bit represents the subband in which the terminal following scheduling will be performed. The terminal following scheduling is a method for allocating a resource to be able to continuously use the UE-specific resource allocated to the UE independent of the movement of the terminal. The UE following bit information may be transmitted to the UE through the control region, while being included in a MAC control element (CE) that is a control message generated in the MAC layer. In contrast, the UE following bit information may be transmitted to the UE using a radio network temporary identifier (RNTI). For example, when the RNTI uses 16 bits, the DU may extend 1 bit to use RNTI of 17 bits. In this case, the extended 1 bit is used as the terminal following bit information. In this case, if the value of the extended 1 bit is 1, the UE following scheduling may be represented.

The UE decodes the control region to set the subband in which the terminal following scheduling will be performed, on the basis of the terminal following bit allocated to the UE. Next, the UE uses the UE-specific resource allocated to the UE among the resources of the subband in which the UE-specific scheduling will be performed, in a time interval (subframe) at which 1 is designated in the UE following scheduling bit map.

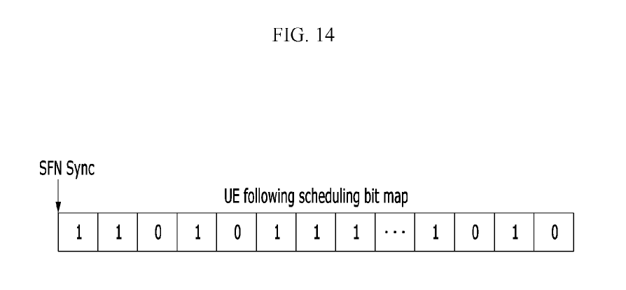

FIG. 14 is a diagram illustrating an example of a terminal following scheduling bit map according to an exemplary embodiment of the present invention.

Referring to FIG. 14, each bit of the UE following scheduling bit map is mapped to each subframe from system frame number (SFN) start timing. The SFN start timing may represent, for example, start timing of subframe 0 of frame 0. If a bit is set to be 1 in the UE following scheduling bit map, the UE uses the UE-specific resource allocated to the UE in the corresponding subframe. The UE following scheduling bit map may be transmitted to the UE through a radio resource control (RRC) message. The UE following scheduling bit map may be transmitted to the UE through the RRC message. The UE following scheduling bit map may also be transmitted through L2 signaling and may be transmitted through the control region of the subframe.

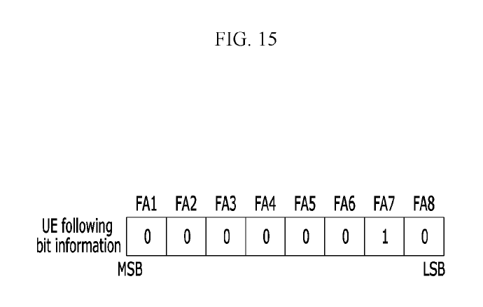

FIG. 15 is a diagram illustrating an example of UE following bit information according to an exemplary embodiment of the present invention.

Referring to FIG. 15, each bit of the UE following bit information is mapped to each subband. If a bit is set to be 1, it is represented that the UE following scheduling is applied to the corresponding subband. For example, if the UE following bit information is 00000010, the UE following scheduling is applied to the subband FA7 corresponding to bit 1, and thus the UE uses the UE-specific resource of the subband FA7 in the time interval (subframe) at which the 1 is designated in the UE following scheduling bit map. The UE following bit information may be transmitted to the UE through the MAC CE.

Meanwhile, the release of the UE following scheduling of the subband in which the UE following scheduling will be performed may be performed on the basis of the UE following bit information of the control region. For example, bit corresponding to the subband in which the UE following scheduling will be released is set to be 0, thereby releasing the UE following scheduling of the corresponding subband.

As a result, if the bit representing the corresponding subband (for example, FA7) is set to be 1 through the control region, the UE connected to the cell of the specific subband (for example, FA7) uses the UE-specific resource allocated to the UE at the time interval at which 1 is set in the UE following scheduling bit map. Meanwhile, if the bit representing the subband in which the UE is connected is set to be 0 from the UE following bit information of the control region at the time interval at which 1 is designated in the UE following scheduling bit map, the UE-specific resource may be released.

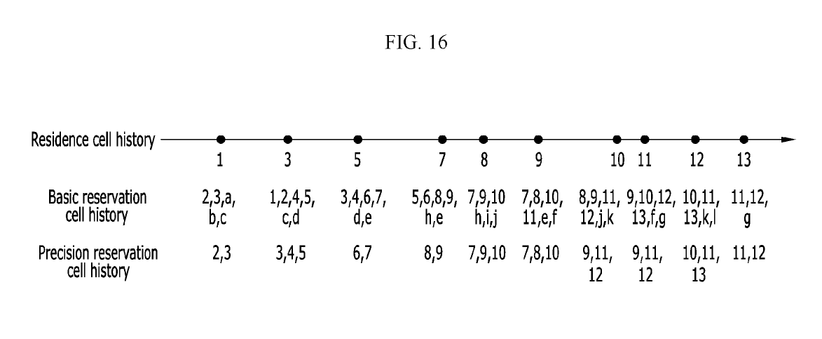

FIG. 16 is a diagram illustrating a resource management method depending on the UE following scheduling according to an exemplary embodiment of the present invention.

Referring to FIG. 16, the actual moving path of the UE is recorded in the residence cell history. The DU that manages the spot element carrier coverages within the overall coverage of the specific subband FA7 may basically order adjacent cells at 1-tier based on the residence cell to reserve the UE-specific resource

That is, the adjacent cells at 1-tier based on the current residence cell of the UE ordering the UE-specific resource reservation are recorded in a basic reservation cell history

For example, when the UE is located in current cell 1, the DU orders adjacent cells 2, 3, a, b, and c at 1-tier of the cell 1 to reserve the UE-specific resource to be allocated to the UE in consideration of the mobility of the UE, in which the corresponding adjacent cells 2, 3, a, b, and c use the reserved UE-specific resource only for the corresponding UE.

In the case of the downlink, the DU transmits data only to the TP of the current residence cell and may not allocate resources to prevent adjacent cells at 1-tier from interfering with each other. Further, the DU may copy data to be transmitted to the TP of the current residence cell and transfer the copied data to adjacent cells at 1-tier, thereby providing the SINR improvement effect by the JT. In the case of the uplink, the UE may basically transmit data with only the resource allocated to the residence cell, the DU may process data with the resource of the corresponding cell, and if the resources of the adjacent cells at 1-tier may be used, data of efficient adjacent cells may also be combined to improve the uplink quality through joint reception (JR).

Meanwhile, when adjacent cells at 1-tier based on the current residence cell of the UE reserves the UE-specific resource, resource waste may occur in the cell at the location where the UE does not actually move. Therefore, to reduce the resource waste, the DU may expect the moving path of the UE using the measurement information (measurement report, CQI, SRS, or the like) and the location information to which the UE is transmitted, the measurement information measured by the DU, the speed information of the UE, or the like. Therefore, the DU may order adjacent cells to reserve resources on the basis of the predicted moving path of the UE. Adjacent cells ordering the resource reservation on the basis of the moving path of the UE are recorded in a precision reservation history. For example, when the UE is located in the current cell 1, the DU may order only adjacent cells 2 and 3 to which the UE is highly likely to move to reserve the UE specific resource based on the predicted moving path of the UE. By doing so, adjacent cells a, b, and c may use the UE-specific resource as the other UE or the other purpose, such that the resource waste may be reduced.

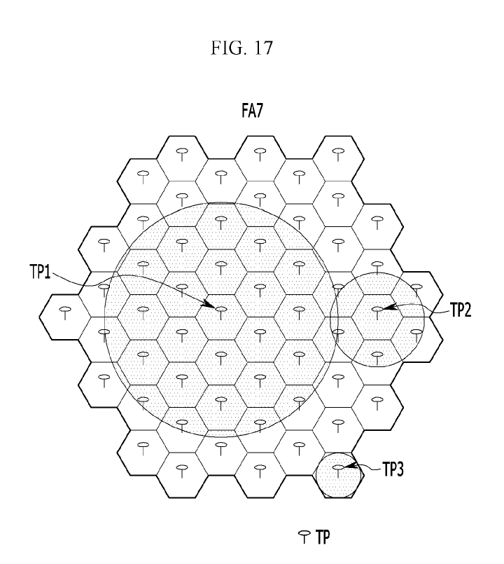

FIG. 17 is a diagram illustrating an example of a power-based dynamic cell configuration according to an exemplary embodiment of the present invention. FIG. 17 illustrates only the TP1, the TP2, and the TP3 for convenience of explanation in the cell configuration illustrated in 500 of FIG. 5 in connection with the specific subband (for example, FA7).

Referring to FIG. 17, when 57 spot element carrier coverage are grouped for the specific subband (for example, FA7) to configure one cell, each TP may differently operate transmit power. For example, the TP1 located at the center of the grouped cell may increase the transmit power to be maximally increased with the spot coverage of the TP1 not deviating from the overall coverage if possible and the TP3 located at the boundary area of the grouped cell fixes the transmit power to form the originally planned spot coverate of the TP3. Meanwhile, the TP2 located between the central area of the grouped cell and the boundary area may control the transmit power so that it is larger than the spot coverage of the TP3 but is smaller than the spot coverage of the TP1 while the spot coverage of the TP2 not deviating from the overall coverage. The control of the transmit power makes the wireless quality good in the grouped cell area without causing the interference.

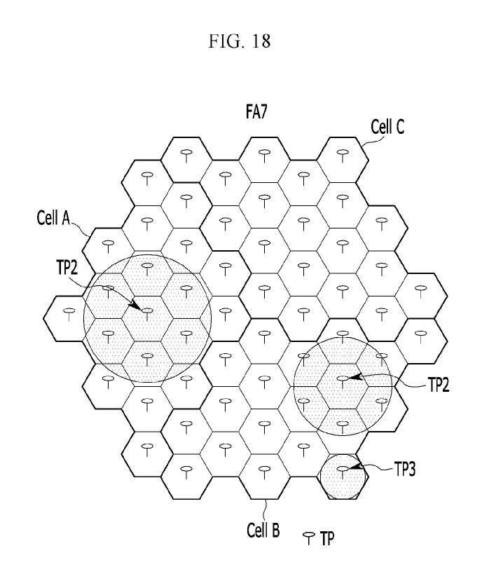

FIG. 18 is a diagram illustrating another example of a power-based dynamic cell configuration according to an exemplary embodiment of the present invention. FIG. 18 illustrates only the TP1, the TP2, and the TP3 in the cell configuration illustrated in 510 of FIG. 5 for the specific subband (for example, FA7).

Referring to FIG. 18, when 57 spot element carrier coverages are grouped as 19 spot element carrier coverages for the specific subband (for example, FA7) to configure three cells within the overall coverage, each TP within each cell may differently operate transmit power. For example, the TP1 located at the center of the cell A may increase the transmit power to be maximally increased with the spot coverage of the TP1 not deviating from the coverage of the cell A if possible and the TP3 located at the boundary area of the cell B fixes the transmit power to form the originally planned spot coverate of the TP3. Further, the TP2 located between the central area of the cell B and the boundary area may control the transmit power so that it is larger than the spot coverage of the TP3 but is smaller than the spot coverage of the TP1 while the spot coverage of the TP2 not deviating from the coverage of the cell B. The control of the transmit power makes the wireless quality good in the grouped cell area without causing the interference.

As illustrated in FIGS. 17 and 18, the TPs within the grouped cell control the coverage based on the transmit power so that they do not deviate from the boundary of the grouped cell region depending on each location, thereby improving the wireless quality of the grouped cell area.

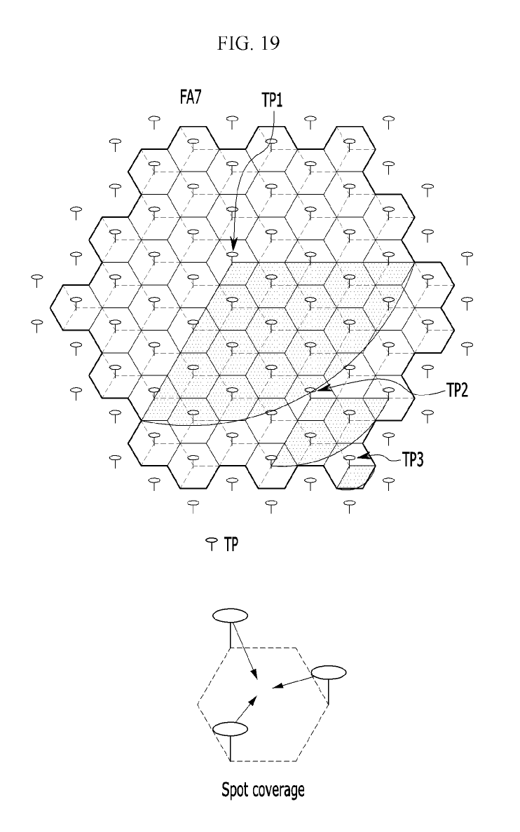

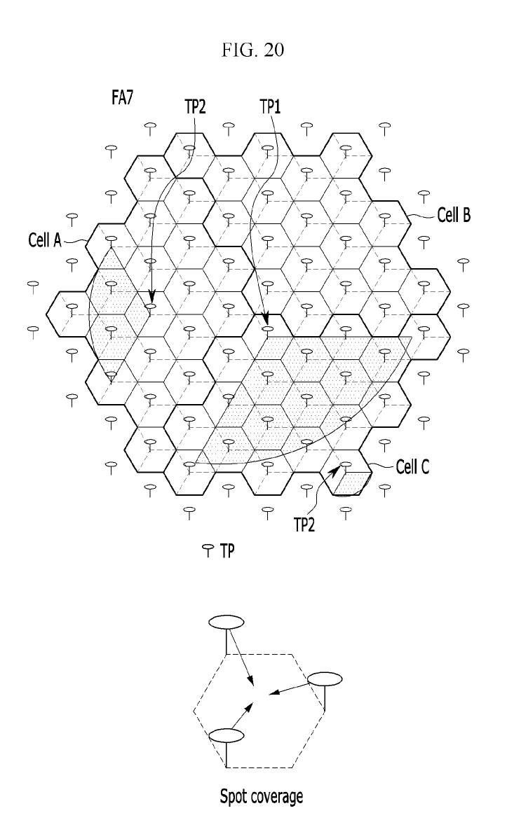

FIGS. 19 and 20 each are diagrams illustrating still another example of a power-based dynamic cell configuration according to an exemplary embodiment of the present invention. In FIG. 19, as illustrated in FIG. 8, when three TPs are collected to form one spot coverage, only the TP1, the TP2, and the TP3 are illustrated in the cell configuration as illustrated in 500 of FIG. 5 within the overall coverage for the specific subband (for example, FA7). In FIG. 20, as illustrated in FIG. 8, when three TPs are collected to form one spot coverage, only the TP1, the TP2, and the TP3 are illustrated in the cell configuration as illustrated in 510 of FIG. 5 within the overall coverage for the specific subband (for example, FA7).

Referring to FIG. 19, when all the spot element carrier coverages are grouped for the specific subband (for example, FA7) to configure one cell, each TP may differently operate transmit power. In this case, each TP forms sector coverage unlike FIG. 17. For example, the TP1 located at the center of the grouped cell may increase the transmit power to be maximally increased with the sector coverage of the TP1 not deviating from the overall coverage if possible and the TP3 located at the boundary area of the grouped cell fixes the transmit power to form the originally planned sector coverage of the TP3. Meanwhile, the TP2 located between the central area of the grouped cell and the boundary area may control the transmit power so that it is larger than the sector coverage of the TP3 but is smaller than the sector coverage of the TP1 while the sector coverage of the TP2 not deviating from the overall coverage. The control of the transmit power makes the wireless quality good in the grouped cell area without causing the interference.

Further, as illustrated in FIG. 20, even when 57 spot element carrier coverages are grouped as 19 spot element carrier coverages for the specific subband to configure three cells within the overall coverage, as described in FIG. 18, each TP within each cell may differently operate transmit power.

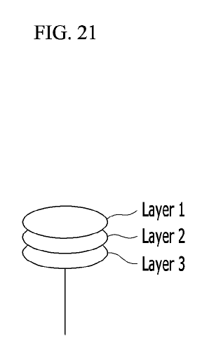

FIG. 21 is a diagram illustrating an example of an antenna according to an exemplary embodiment of the present invention.

Referring to FIG. 21, one antenna (TP) may support a plurality of layers. The layer may mean an independent stream having other information simultaneously transmitted. For example, one antenna (TP) may support three layers.

As such, when the antenna supporting three layers is used, one subband may be divided into three layers. Therefore, in the case of the antenna supporting one layer as illustrated in FIG. 2, 57 spot element carrier coverages provided in the specific subband (for example, FA7) may be provided, but in the case of using the antenna supporting three layers, 171 spot element carrier coverages may be provided. At this point, as illustrated in FIG. 3, when the overall system bandwidth is divided into 8 subbands FA1, FA2, FA3, FA4, FA5, FA6, FA7, and FA8 and operated, a total of 1368 spot element carrier coverages within one overall coverage may be provided.

The so logically extended spot element carrier coverages may configure the cell as illustrated in FIG. 5 per the specific layer of the specific subband and may make the cell configuration and the cell operation as described above in consideration of the subband and the layer.

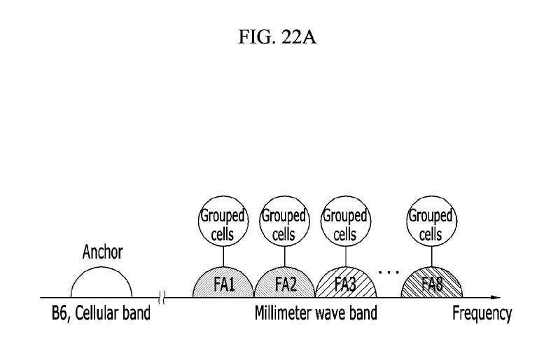

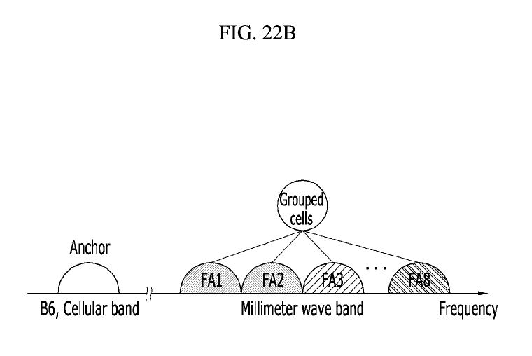

FIGS. 22A and 22B are diagrams illustrating an example of a method for operating a dynamic cell according to an exemplary embodiment of the present invention.

Referring to FIGS. 22A and 22B, a cellular frequency band corresponding to B6 GHz is used as the coverage layer and the cell within the coverage layer is configured to be a primary cell or an anchor cell and the above-mentioned millimeter wave band may be used as the capacity layer. That is, the system using the above-mentioned millimeter wave band is not independently operated and may serve as an auxiliary system providing the capacity in the existing cellular system. Here, the primary cell or the anchor cell which is the cell of the coverage layer to which the UE is continuously connected may be defined as a cell transmitting the control information for adding/deleting/changing the cell of the capacity layer to the UE.

As such, the existing cellular frequency band B6 may be operated in terms of the coverage layer for mobility and the millimeter band may be operated as the capacity layer to be used to provide large capacity data. At this point, as illustrated in FIG. 22A, cells may be independently operated in each subband and as illustrated in FIG. 22B, cells in all subbands may be integrally operated. For example, when the cell is configured by the scheme as illustrated in 510 of FIG. 5 for 8 subbands, as illustrated in FIG. 22A, a total of 24 cells are operated and as illustrated in FIG. 22B, a total of three cells are operated.

In addition, when cells are configured as different cell configurations per subband and are operated based on FIG. 22B by connecting the cell regions overlapping each other, the 3D cell having various 3D shapes may also be configured when viewed three dimensionally.

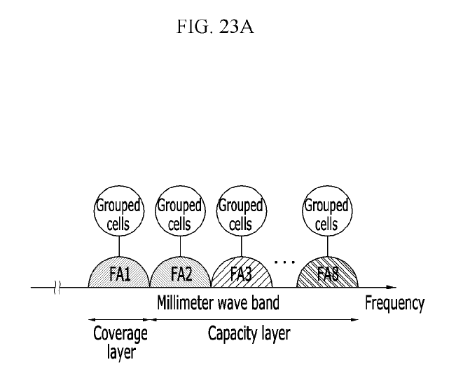

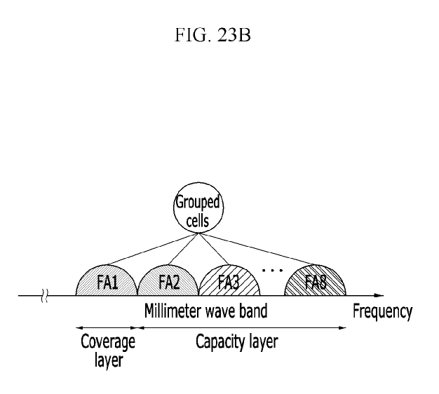

FIGS. 23A and 23B are diagrams illustrating another example of a method for operating a dynamic cell according to an exemplary embodiment of the present invention.

Referring to FIGS. 23A and 23B, unlike FIGS. 22A and 22B, the existing cellular frequency band corresponding to the B6GHz is not used at all and only the millimeter band may also be operated.

The system using the millimeter band may use one or more subband among the subbands FA1 to FA8 as the coverage layer and use the rest subbands as the capacity layer. For example, the subband FA1 may be used as the coverage layer and the rest subbands FA2 to FA8 may be used as the capacity layer. At this time, one of the grouped cells of the subband FA1 may be set as the primary cell or the anchor cell.

As such, even in the system using only the millimeter wave band, as illustrated in FIG. 23A, the cells may be independently operated in each subband F1 to F8 and as illustrated in FIG. 23B, the cells of the subbands F2 to F8 defined as the capacity layer may be integrally operated.

In addition, as illustrated in FIGS. 22A and 22B, when cells are configured as different cell configurations per subband and are operated based on FIG. 23B by connecting the cell regions overlapping each other, the 3D cell having various 3D shapes may also be configured when viewed three dimensionally.

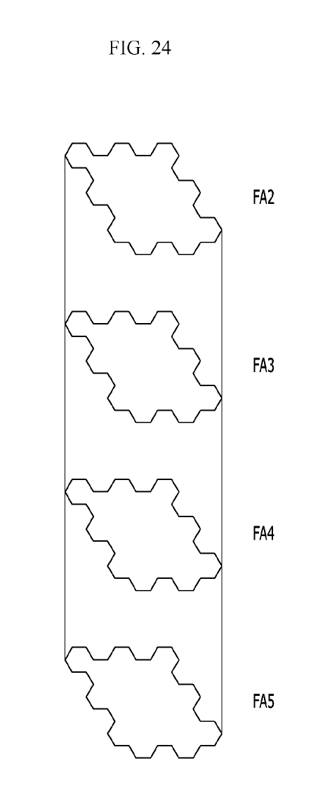

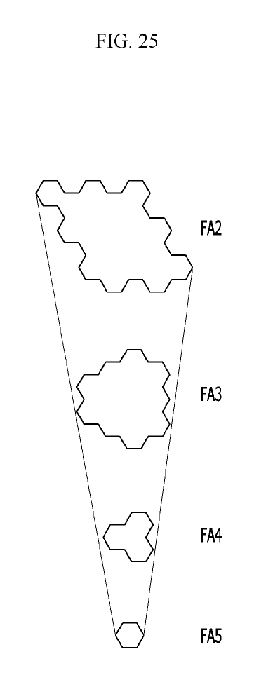

FIG. 24 is a diagram illustrating the same type of grouped cells per subband and FIG. 25 is a diagram illustrating other types of grouped cells per subband.

As illustrated in FIG. 24, the same type of grouping cells may be formed in the subbands FA2, FA3, FA4, and FA5. In this case, as illustrated in FIGS. 22B and 23B, the grouping cells of the subbands FA2, FA3, FA4, and FA5 may be operated while being integrated into one cell. The cell operating method as described above is easy to support the large capacity to the UE requiring large capacity traffic. Further, as illustrated in FIGS. 22A and 23A, when the grouped cell is independently operated per subband, the independent resource region is configured per subband. Therefore, if the same type of grouping cell is formed per subband FA2, FA3, FA4, and FA5 illustrated in FIG. 24, traffic of the UE may offload to the UE using the cell without a load.

Meanwhile, grouping cells having different size per subband FA2, FA3, FA4, and FA5 may also be formed. When the grouping cells of the subband FA2, FA3, FA4, and FA5 are integrally operated as illustrated in FIGS. 22B and 23B, the grouping cells of the subbands FA2, FA3, FA4, and FA5 are handled as a cell. Therefore, if the grouping cells of the subbands FA2, FA3, FA4, and FA5 are formed as illustrated in FIG. 25, even when the UE moves within the grouped cell of the subband DELETEDTEXTS at a low speed and then suddenly moves at a high speed, the resource allocation may be very easy.

As a result, in FIGS. 22A and 23A, the grouped cells are independently operated per subband, and therefore the process of adding/deleting/changing grouped cells is made through L3 signaling, such that rapid application may be impossible and it may be slightly difficult to support QoS seamlessly and without deterioration in the QoS

In contrast, the grouped cells of each subband are integrally operated in FIGS. 22B and 23B, and therefore the process of managing grouped cells of each subband is not required and the rapid resource allocation may be made.

As the cell configuration procedure, there are two schemes of semi-static cell selection and dynamic cell selection. The cell may mean a cell configured depending on the cell configuration as illustrated in FIG. 5. The semi-static cell selection scheme means a scheme of reconfiguring a cell in a relatively long time unit (for example, hundreds of millimeter seconds or more) of the cell change during communication. The semi-static cell selection scheme may be used in the case in which the use time for the cell belonging to the capacity layer is not changed relatively quickly. The dynamic cell selection scheme may select and use the cells of the layer having the low interference and load based on the continuous measurement and may be used for the purpose of increasing the overall radio resource use efficiency of the system. Further, the dynamic cell selection scheme is similar to the semi-static cell selection scheme except for the time requirement, and therefore uses the same procedure as the semi-static cell selection scheme.

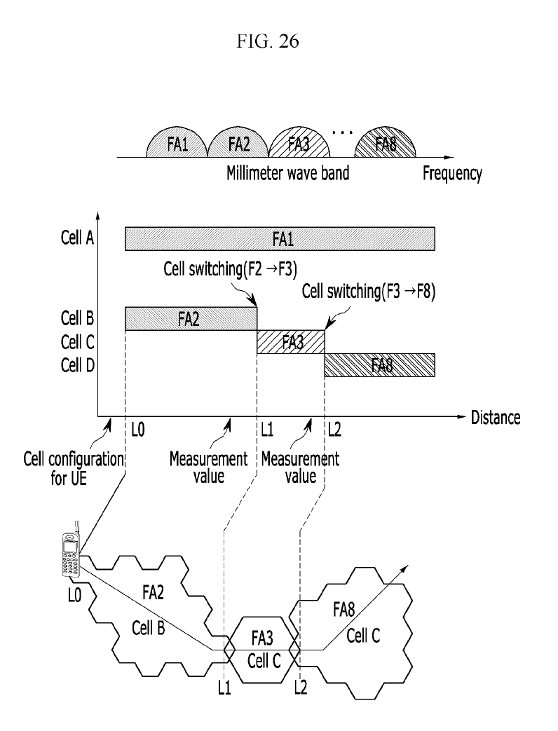

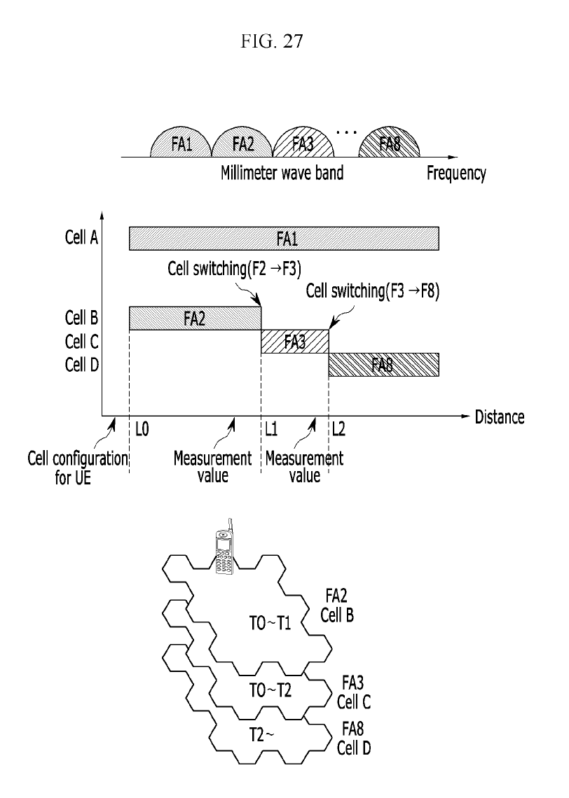

FIGS. 26 and 27 each are diagrams illustrating an example of a communication method using a dynamic cell selection in a millimeter wave-based system according to an exemplary embodiment of the present invention, which for convenience, is described based on the operating method of FIG. 23 but may be applied to the operating method illustrated in FIGS. 22A and 22B.

Referring to FIGS. 26 and 27, when the subband F is operated as the coverage layer and the subbands F2 to F8 are operated as the capacity layer, the UE is always connected using the cells of the subband F1 as the anchor and the capacity may be provided to the UE using the cells belonging to the subbands F2 to F8.

As method for moving cell B of the using subband F2 to cell C of the subband F3 and cell D of the subband F8, there are a method for switching to cells of other subbands based on a distance as illustrated in FIG. 26 and a method for switching to cells of other subbands based on time as illustrated in FIG. 27, based on various measurement values.

Referring to FIG. 26, the DU adds the cell B belonging to the subband F2 to the UE and activates the cell B before point L0 to provide required capacity to the UE. The UE may be connected to the cell B belonging to the subband F2 at point L0 to be provided with capacity. The DU adds the cell C of the subband F3 corresponding to the capacity layer to the UE in response to the movement of the UE and performs the cell switching to the cell B just before point L1 by the wireless measurement. The switching may be performed through the activation MAC CE. Similarly, the cell C belonging to the subband F8 is added and the switching to the cell C just before point L2 is performed. The addition of the cell to be switched needs to be performed before the cell switching and be made by a method for multi-adding a potential cell to be used to provide capacity and may be made in a form of minimizing power consumption of the UE.

As a result, the cells of other subbands may be selected based on a position to select the cell of the capacity layer and the cells corresponding to the subbands F2, F3, and F8 do not completely overlap each other but may slightly overlap each other at a boundary.

Meanwhile, referring to FIG. 27, the DU adds B belonging to the subband F3 corresponding to the capacity layer to the UE before time T1 to provide the required capacity to the UE based on the load state determination in each subband at the fixed location without the movement of the UE, in the state in which the UE is connected to the cell B belonging to the subband F2 at the time of time T0 to be provided with capacity. The switching to the cell C just before time L1 is performed through the wireless quality and the load measurement. Similarly, the DU adds the cell D belonging to the subband F8 to the UE and performs the switching to the cell D just before time T2. The addition of the cell to be switched needs to be performed before the cell switching and be made by a method for multi-adding a potential cell to be used to provide capacity and may be made in a form of minimizing power consumption of the UE.

As illustrated in FIGS. 26 and 27, the reason of determining the switching to the cell belonging to other subbands is to increase the frequency use efficiency and minimize a discontinuous transmission.

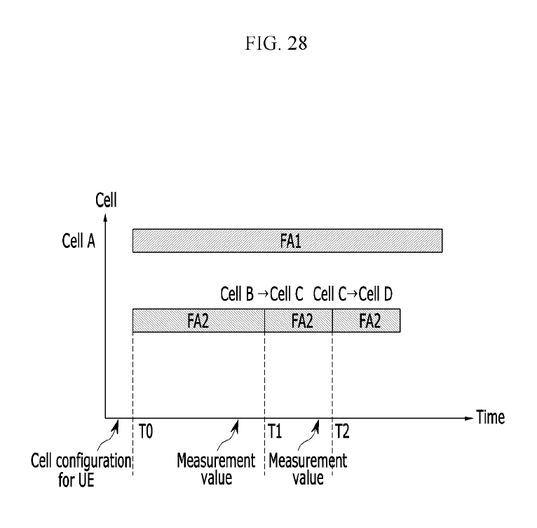

FIG. 28 is a diagram illustrating an example of a dynamic cell selection within one subband.

Referring to FIG. 28, the DU may move the capacity layer only to the cell belonging to one subband F2 to provide the required capacity to the UE. In this case, even if all of the cell B, cell C, and cell D are added to the UE, hard switching is generated while the cell is switched in one subband F2, and therefore the instantaneous interruption of services occurs and the QoS fundamentally deteriorates at the boundary between the cells.

On the other hand, if the switching to the cells of other subbands is made based on a distance or time, the deterioration in QoS may be reduced due to the cell boundary and services may be provided without the interruption due to the hard switching. The cell B, the cell C, and the cell D may overlap each other and if the switching to the cells of other subbands is made in the overlapping section, better QoS may be maintained than the method illustrated in FIG. 28.

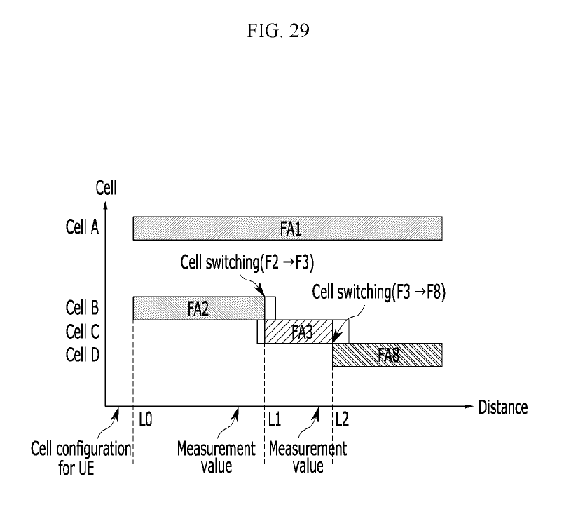

FIGS. 29 to 32 are diagrams illustrating an example of performing cell switching to other subbands to provide capacity to each UE.

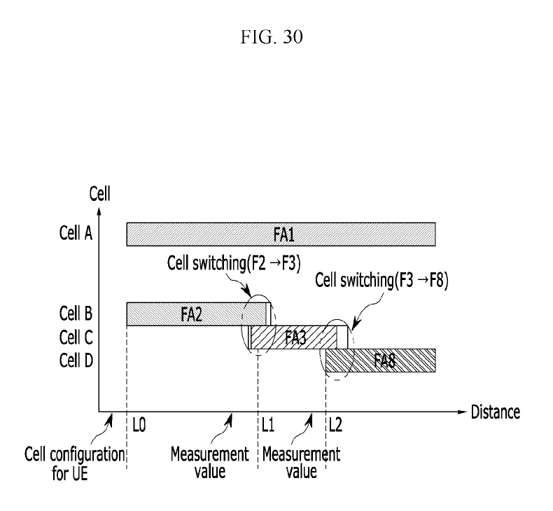

Referring to FIGS. 29 and 30, the cell B and the cell C may partially overlap each other and the cell C and the cell D may partially overlap each other. The DU may perform the switching of the cells of other subbands in the inter-cell overlapping section.

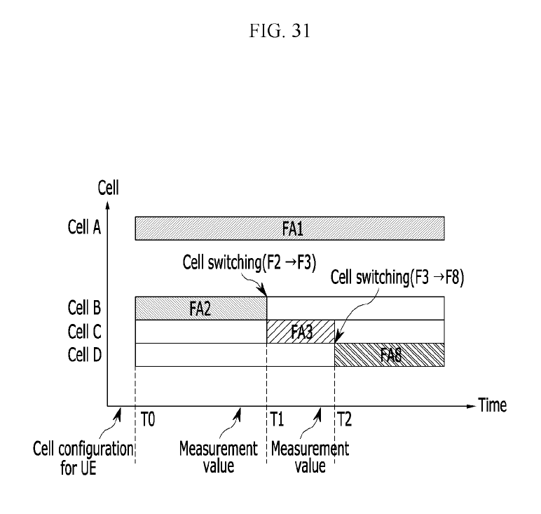

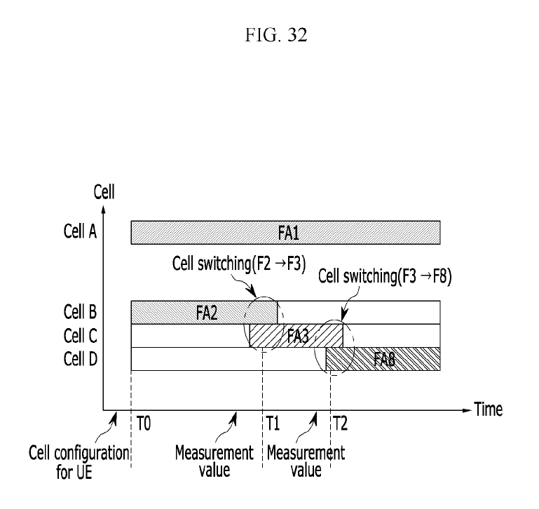

In contrast, referring to FIGS. 31 and 32, the cell B, the cell C, and the cell D may completely overlap each other and the DU may perform the switching to the cells of other subbands based on time.

In this case, as illustrated in FIGS. 29 and 31, it is possible to deactivate a source cell (cell before the cell switching) simultaneously with activating a target cell (cell to be switched). In contrast, as illustrated in FIGS. 30 and 32, the target cell may be activated prior to deactivating the source cell during at least some section. That is, the DU may activate the target cell based on the wireless measurement information (for example, CQI, or the like) of the serving cell and the target cell and then deactivate the source cell. In this case, if moving to other cells in providing the capacity, the DU may simultaneously transmit the same data to the UE in the source cell and the target cell in a predetermined overlapping section and allow the UE to select better quality of data. Further, the UE may simultaneously transmit the same data to the source cell and the target cell and the DU may select better quality of data.

The cell switching method illustrated in FIGS. 30 and 32 may more improve the delay or the QoS due to the cell switching than the cell switching method illustrated in FIGS. 29 and 31.

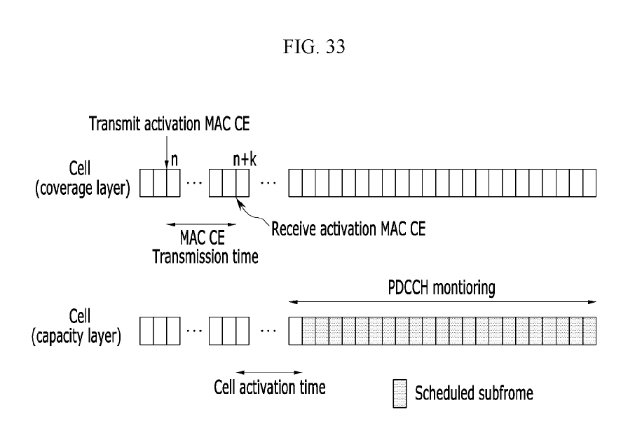

In carrier aggregation (CA) of the existing long term evolution-advanced (LTE-A) system, a secondary (S) cell is activated, the S cell activation/deactivation signaling of the MAC layer is used to monitor the scheduling information of the activated S cell, and it takes up to tens of millimeter seconds to transmit the MAC CE for the S cell activation/deactivation signaling. To control the activation/deactivation of the grouped cell operated in the above-mentioned system using the procedure provided in the CA of the existing LTE-A system, the problem as illustrated in FIG. 33 occurs.

FIG. 33 is a diagram illustrating an example of applying an activation/inactivation control method of an S cell presented in CA of the existing LTE-A system to a cell of a capacity layer according to an exemplary embodiment of the present invention.

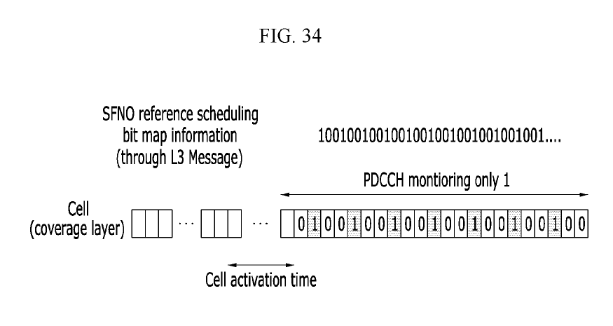

Referring to FIG. 33, if the activation/deactivation control method of the S cell provided in the CA of the existing LTE-A system is applied to the cell of the capacity layer according to the exemplary embodiment of the present invention, the base station transmits the activation MAC CE for the activation of the cell of the capacity layer to the UE through the cell of the coverage layer at subframe n and the UE receives the corresponding activation MAC CE through the cell of the coverage layer at subframe (n+k). The UE receives the activation MAC CE and then continuously monitors a physical downlink control channel (E)PDCCH including scheduling information on the cell of the corresponding capacity layer after the time to activate the cell of the capacity layer. However, if the PDCCH of the corresponding cell is monitored to confirm that the UE is continuously allocated the resource of the cell corresponding to the capacity layer, unnecessary power consumption occurs. Therefore, a method for solving the problem while performing the dynamic cell configuration procedure according to the exemplary embodiment of the present invention will be described with reference to FIG. 34.

FIG. 34 is a diagram illustrating a method for activating or deactivating a cell of a capacity layer according to an exemplary embodiment of the present invention.

Referring to FIG. 34, when the cell to be switched is added to the UE, the DU transmits bit maps (for example, 4096 bits) starting at an absolute reference time like SFN0. The UE may receive the corresponding activation MAC CE through the cell of the coverage layer at subframe (n+k) and then monitor only the subframe corresponding to bit that is 1 in the received bit map from the subframe after the actual time for the cell activation is lapses, thereby reducing the power consumption of the UE. The DU may transmit the bit map through the MAC CE and may also transmit the relevant information added to the MAC message by defining the resource location and resource allocation forms in addition to the bit map. Instep of the bit map, the resource allocation of the semi-static same period may be used. For example, the UE may receive the PDCCH only once and continuously use the resource indicated in the first PDCCH at a predetermined period from that time.

As such, a method for designating a subframe where PDCCH will be monitored on time and frequency by using a bit map may be considered to provide capacity to the UE when the location of the UE is not suddenly changed.

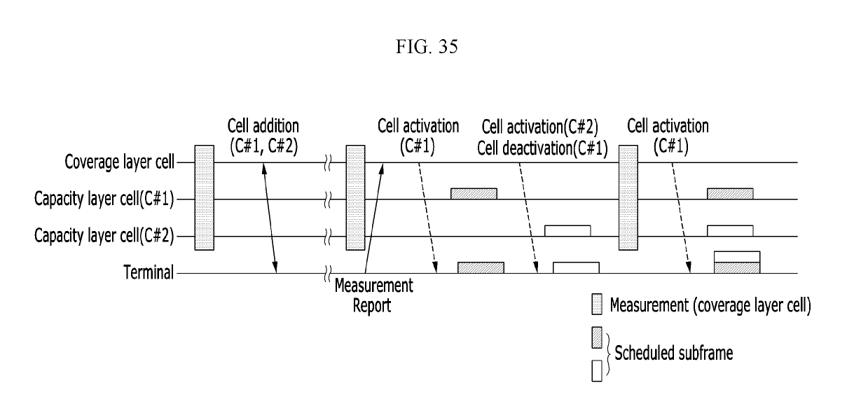

FIG. 35 is a diagram describing a method for dynamically allocating a cell resource of a subband corresponding to a capacity layer according to an exemplary embodiment of the present invention.

Referring to FIG. 35, the cell of the coverage layer measures the wireless quality and the load for adjacent cells corresponding to its own cell and the coverage layer and measures the wireless quality and the load for the cells corresponding to several subbands at the coverage layer or measures the wireless quality periodically and in event manner. The measurement information may be used for addition/removal/change of the capacity layer cell through an L3 message or used the activation/deactivation of the capacity layer cell.

The coverage layer cell uses a radio resource control (RRC) connection reconfiguration message disclosed in the LTE-A system based on the measurement information if necessary to add capacity layers cell C#1 and C#2 to the UE through the coverage layer cell.

Next, the UE transmits measurement report (MR) information to the coverage layer cell and the coverage layer cell uses its own measurement information measured and the MR information transmitted by the UE to select the activation and deactivation cells within the capacity layer cell list set in the UE.

If the coverage layer cell selects the capacity layer cell C#1 as the activation cell, the capacity layer cell C#1 is activated using the MAC CE-based S cell activation and then after the activation, the subframe for transmitting/receiving actual data is scheduled.

Meanwhile, if the coverage layer cell selects the capacity layer cell C#1 as the deactivation cell and the capacity layer cell C#2 is selected as the activation cell, the MAC CE-based S cell activation/deactivation is used to activate the capacity layer cell C#2 and deactivate the capacity layer cell C#1. Further, the subframe to transmit/receive actual data is scheduled in the activated capacity layer cell C#2.

Further, if the coverage layer cell simultaneously selects the capacity layer cells C#1 and C#2 as the activation cell, the capacity layer cell C#1 and C#2 are activated using the MAC CE-based S cell activation and the subframe for transmitting/receiving actual data is scheduled in the activated capacity layer cells C#1 and C#2. In this case, different data may be transmitted to the capacity layer cells C#1 and C#2 and the same data may be transmitted to allow the receiving UE to select better data.

As such, the coverage layer cell may add cells for several subbands to the UE and then use the MAC CE activation function of the coverage layer cell to dynamically allocate the cell resource of the subband corresponding to several capacity layers.

Meanwhile, the cell activation/deactivation methods described in FIGS. 34 and 35 are used together and thus the dynamic selection for the cell is performed and the semi-static resource allocation within the selected cell may be performed within the selected cell.

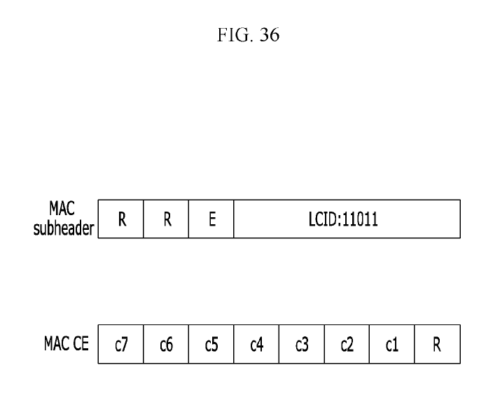

FIG. 36 is a diagram illustrating a method for activating or deactivating an MAC CE-based S cell according to an exemplary embodiment of the present invention.

Referring to FIG. 36, each bit location c7, c6, c5, c4, c3, c2, and c1 of the MAC CE is mapped to a cell identifier, and a cell mapped to a bit location set as 1 is activated and a cell mapped to a bit location set as 0 is deactivated. That is, each cell from the MAC CE may be activated/deactivated. The bit number of the MAC CE may be extended depending on the number of subbands corresponding to the capacity layer cell.

A MAC subheader corresponding to the MAC CE may include R, R, E, and logical channel ID (LCID) fields. The LCID field is a field for identifying the corresponding MAC CE and for example, the LCID representing the MAC CE for activating/deactivating a cell may be set to be 11011. The extension (E) field is a flag identifying whether other fields are present in the MAC header and when being set to be “1”, represents that another set of at least R/R/E/LCID field is present and when being set to be “0”, represents that MAC SDU and MAC CE start at a subsequent byte. The reserved (R) field is a reserved field and is set to be “0”.

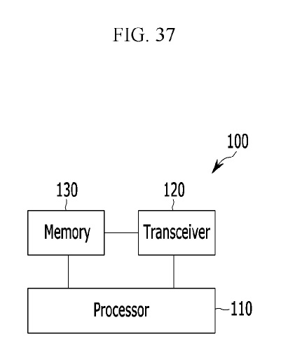

FIG. 37 is a diagram illustrating a distributed multi-points coordinated dynamic cell control apparatus according to an exemplary embodiment of the present invention.

Referring to FIG. 37, a distributed multi-points coordinated dynamic cell control apparatus 100 includes a processor 110, a transceiver 130, and a memory 310. The distributed multi-points coordinated dynamic cell control apparatus 100 may be implemented within a central server that centrally manages the DUs and may also be implemented within the DU.

The processor 100 may configure the dynamic cell as illustrated in FIGS. 1 to 36 and operate the cell and add/delete/change the grouped cell. Further, the resource of the grouped cell of the processor 110 may managed. The processor 210 may mean a central processing unit (CPU), a graphics processing unit (GPU), or an exclusive processor that performs methods according to exemplary embodiments of the present invention.

The transceiver 120 is connected to the processor 110 to transmit and receive a wireless signal. 1

The memory 130 stores instructions which are performed by the processor 110 or loads instructions from a storage (not illustrated) and temporarily stores the instructions and the processor 110 executes the instructions which are stored or loaded in the memory 130.

The processor 110 and the memory 130 are connected to each other through a bus (not illustrated) and an input/output interface (not illustrated) may also be connected to the bus. In this case, the transceiver 120 is connected to the input/output interface and peripheral devices such as an input device, a display, a speaker, and a storage device may be connected to the input/output interface.

According to an exemplary embodiment of the present invention, in the case of processing, by the single central processing unit, the antennas [or transmission points (TPs)] locally distributed disposed, the bandwidth of the wideband system may be operated by being divided into several subbands, various grouping methods may be selected depending on the coverages of each antenna per subband as a minimum unit, and the grouping method may be changed per subband, such that the system may be adaptively operated depending on the interference, the mobility, and the time-spatial requirements of the capacity, thereby securing the mobility of the UE, expanding the coverage, and providing the proper capacity depending on the location of the UE and the mobility.

Further, it is possible to effectively provide the required capacity to the UE by using effectively the cell of the capacity layer based on the combination of the cell defined as the capacity layer with the cell defined as the coverage layer.

The exemplary embodiments of the present invention are not implemented only by the apparatus and/or method as described above, but may be implemented by programs recorded in a recording medium for realizing the functions corresponding to the configuration of the exemplary embodiments of the present invention or the recording medium recorded with the programs, which may be readily implemented by a person having ordinary skill in the art to which the present invention pertains from the description of the foregoing exemplary embodiments.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A control method of a distributed multi-points coordinated dynamic cell for managing a plurality of transmission points (TPs), comprising:
configuring at least one grouping cell by logically grouping a plurality of spot coverages formed by the plurality of TPs within an overall coverage in a plurality of subbands, respectively, within an overall system band;
operating at least one of the plurality of subbands as a capacity layer for providing capacity to UE; and
operating at least another band or other bands amon the plurality of subbands as a coverage layer to which the UE is always connected.

2. The control method of claim 1, wherein:
the operating at least one of the plurality of subbands as the capacity layer includes adding at least one cell of the capacity layer to the UE or deleting or changing the at least one cell from the UE, through a cell of the coverage layer.

3. The control method of claim 1, wherein:
the operating at least one of the plurality of subbands as the capacity layer includes:
adding a grouping cell of at least one subband corresponding to the capacity layer to the UE based on a measurement report from the UE;
selecting a grouping cell to be activated among the grouping cells added to the UE; and
activating the selected grouping cell.

4. The control method of claim 3, wherein:
the operating at least one of the plurality of subbands as the capacity layer further includes designating a subframe to be monitored to allow the UE to confirm scheduling information of the activated cell and transmitting the designated subframe to the UE.

5. The control method of claim 4, wherein:
the transmitting includes transmitting a bit map representing the subframe to be monitored to the UE.

6. The control method of claim 3, wherein:
the activating includes switching a grouping cell of any one subband corresponding to the capacity layer to grouping cells of other subbands corresponding to the capacity layer, based on a distance or time, and
the grouping cell of any one subband and the grouping cells of the other subbands at least partially overlap each other.

7. The control method of claim 6, wherein:
the switching includes activating the grouping cells of the other subbands, prior to deactivating the grouping cell of the any one subband.

8. The control method of claim 6, wherein:
the switching includes deactivating the grouping cell of the any one subband after deactivating the grouping cell of the any one subband.

9. The control method of claim 3, wherein:
the activating includes transmitting a MAC control element, and
each bit of the MAC control element is mapped to the grouping cells of each subband and the activation and the deactivation of the corresponding grouping cell are determined depending on values of each bit.

10. The distributed multi-points coordinated dynamic cell control method of claim 1, further comprising:
individually performing resource allocation on the grouping cells of the plurality of subbands, respectively or integrally the grouping cells of the plurality of subbands to perform the resource allocation on the grouping cells.

11. The distributed multi-points coordinated dynamic cell control method of claim 1, wherein:
the configuring includes forming one spot coverage as a sector coverage formed by at least two TPs located at different locations, and
the coverage formed by one TP is divided into a plurality of sector coverages and the overall coverage is formed as a coverage by the plurality of TPs.

12. A distributed multi-points coordinated dynamic cell control apparatus for managing a plurality of transmission points (TPs), comprising:
a processor dividing an overall system band into a plurality of subbands, operating at least one of the plurality of subbands as a capacity layer for providing capacity to UE, operating at least another band or other bands among the plurality of subbands as a coverage layer to which the UE is always connected, configuring at least one cell within overall coverage using spot coverage formed by the plurality of TPs in the plurality of subbands, respectively, and adding a cell of the coverage layer to the UE or changing or deleting the cell of the capacity layer added to the UE through the cell of the coverage layer; and
a transceiver transmitting/receiving a radio signal for adding, changing, or deleting the cell of the capacity layer.

13. The distributed multi-points coordinated dynamic cell control apparatus of claim 12, wherein:
the processor logically groups the plurality of spot coverages in the plurality of subbands, respectively, to configure at least one cell and forms one spot coverage as a sector coverage formed by at least two TPs located at different locations, and
the coverage formed by one TP is divided into a plurality of sector coverages and the overall coverage is formed as a coverage by the plurality of TPs.

14. The distributed multi-points coordinated dynamic cell control apparatus of claim 12, wherein:
the processor adds the cell of at least one capacity layer to the UE through the cell of the coverage layer and uses a MAC control element to dynamically activate and deactivate the cell of the subband corresponding to the capacity layer.

15. The distributed multi-points coordinated dynamic cell control apparatus of claim 14, wherein:
each bit of the MAC control element is mapped to the grouping cells of each subband and the activation and the deactivation of the corresponding grouping cell are determined depending on values of each bit.

16. The distributed multi-points coordinated dynamic cell control apparatus of claim 12, wherein:
the processor determines switching a grouping cell of any one subband corresponding to the capacity layer to grouping cells of other subbands corresponding to the capacity layer, based on a distance or time and activates the grouping cells of the other subbands, prior to deactivating the grouping cell of the any one subband, and
the grouping cell of any one subband and the grouping cells of the other subbands at least partially overlap each other.

17. A distributed multi-points coordinated dynamic cell configuration method by an apparatus for managing a plurality of transmission points (TPs), comprising:
forming one spot coverage as a sector coverage formed by at least two TPs located at different locations, and
configuring at least one cell by logically grouping a plurality of virtualization spot coverages formed within an overall coverage,
wherein the coverage formed by one TP is divided into a plurality of sector coverages and the overall coverage is formed as a coverage by the plurality of TPs.

18. The distributed multi-points coordinated dynamic cell configuration method of claim 17, further comprising:
dividing an overall system band into a plurality of subbands and operating the overall system band;
wherein the configuring includes grouping the plurality of virtual spot coverages into the at least one cell using one virtualization spot coverage as a minimum unit, in the plurality of subbands, respectively.

19. The distributed multi-points coordinated dynamic cell configuration method of claim 17, further comprising:
selecting a cell of at least one of the plurality of subbands as a cell of a coverage layer to which UE is always connected; and
selecting at least one cell of at least another subband of the plurality of subbands
as a cell of a capacity layer to which the UE is additionally connected to provide capacity to the UE.

20. The distributed multi-points coordinated dynamic cell configuration method of claim 19, wherein:
the selecting includes dynamically changing the cell of the capacity layer based on at least one of interference, mobility, and capacity.
